(19) United States
(12) Patent Application Publication
(10) Pub. No.: US 2016/0259865 A1
(43) Pub. Date: Sep. 8, 2016

(54) Package Testing

(71) Applicant: Axiom Consulting Private Limited, Bangalore (IN)

(72) Inventors: Harish Neerukonda, Bangalore (IN); Chandrasekhar Jagannath Arcot, Bangalore (IN); Lakshminarayana Giridhar, Bangalore (IN); Satya Simha Rao, Bangalore (IN)

(73) Assignee: Axiom Consulting Private Limited, Bangalore (IN)

(21) Appl. No.: 15/058,213

(22) Filed: Mar. 2, 2016

(30) Foreign Application Priority Data
Mar. 4, 2015 (IN) 1047/CHE/2015

(51) Int. Cl. G06F 17/50; G06F 17/10

(52) U.S. Cl. CPC G06F 17/50; G06F 17/10

(57) ABSTRACT

The present subject matter discloses systems and methods for managing patents in an enterprise. In one implementation, the method includes generating a package testing equation utilizing a interpolation constant and a secondary input data and computing one or more of a stress, a strain, a damage coefficient, collective stress collective strain and collective damage coefficient utilizing the package testing equation and the secondary input data, wherein the damage coefficient is indicative of the damage sustained by the package. Further, evaluating the package design based one or more of a stress, a strain, a damage coefficient, collective stress collective strain and collective damage coefficient and a failure identification matrix to enable optimized package design.

The following specification particularly describes the invention and the manner in which it is to be performed:

### TECHNICAL FIELD OF THE INVENTION

The present subject matter relates, in general, to testing and, in particular, to systems and methods for package testing.

### BACKGROUND OF THE INVENTION

Generally, packaging is the science, art, and technology of enclosing or protecting products for distribution, storage, sale, and use. In addition, packaging also refers to the process of design, evaluation, and production of packages. In other words packaging may also be described as a coordinated system of preparing goods for transport, warehousing, logistics, sale, and end use. Packaging contains, protects, preserves, transports, informs, and sells.

Typically, corrugated fiberboard sometimes known as corrugated board or corrugated cardboard, which is a combined paper-based material consisting of one or more layers of a fluted corrugated medium and one or two flat linerboards, is used for packaging goods. Such corrugated fiberboard typically formed in to boxes for packaging goods. Corrugated boxes are used frequently as shipping containers. Corrugated boxes provide some measure of product protection by themselves but often require inner components such as cushioning, bracing and blocking to help protect fragile contents and increasing the strength of the corrugated boxes.

Corrugated box design and testing is the process of matching design factors for corrugated fiberboard boxes with the functional physical, processing and end-use requirements and then testing the same for durability. Generally, engineers work to meet the performance requirements of a box while controlling total costs.

### SUMMARY OF THE INVENTION

This summary is provided to introduce concepts related to systems and methods of package testing and optimization, and the concepts are further described below in the detailed description. This summary is neither intended to identify essential features of the claimed subject matter nor is it intended for use in determining or limiting the scope of the claimed subject matter.

In one implementation, the method includes, generating a package testing equation utilizing a interpolation constant and a secondary input data and computing one or more of a stress, a strain, a damage coefficient, collective stress collective strain and collective damage coefficient utilizing the package testing equation and the secondary input data, wherein the damage coefficient is indicative of the damage sustained by the package. Further, evaluating the package design based one or more of the computed stress, strain, damage coefficient, collective stress collective strain and collective damage coefficient and a failure identification matrix to enable optimized package design.

### BRIEF DESCRIPTIONS OF DRAWINGS

The detailed description is described with reference to the accompanying drawings. In the figures, the left-most digit(s) of a reference number identifies the drawing in which the reference number first appears. The same numbers are used throughout the drawings to reference like/similar features and components.

FIG. 1 illustrates a network environment implementing a package testing primary system, according to an embodiment of the present subject matter.

FIG. 2 illustrates a network environment implementing a package testing secondary system, according to an embodiment of the present subject matter.

FIG. 3 illustrates the package testing primary system, according to an embodiment of the present subject matter.

FIG. 4 illustrates the package testing secondary system, according to an embodiment of the present subject matter.

FIG. 5a illustrates an exemplary method of package testing and optimization, according to an embodiment of the present subject matter.

FIG. 5b illustrates an exemplary method of package testing and optimization, according to an embodiment of the present subject matter.

### DETAILED DESCRIPTION OF THE INVENTION

System and method for package testing are described herein. The system and method for package testing can be implemented in variety of computing systems. Examples of such computing system include but are not restricted to High Performance Computing (HPC) main frame computers, workstation, minicomputers, servers, multiprocessor system, laptop, network server and the like.

As discussed, packaging is the science, art, and technology of enclosing or protecting products for distribution, storage, sale, and use. Further, packaging is classified in to primary packaging, secondary packaging and tertiary packaging. Primary packaging is that which surrounds a product when sold to a final consumer. Primary packaging is most often seen by the consumer and that of which they are most conscious. Primary packaging is also in direct contact with the product which adds complexity in terms of food safety requirements, hygiene requirements, etc. Primary packaging includes packaging material in the primary pack, such as a label on a jar, a cardboard sleeve on a tray, or a lid on a bottle.

Secondary or grouped packaging is that which is used to collate primary units for ease of handling in the selling environment. Typically, secondary packaging can be corrugated cardboard boxes or trays, containing a number of primary units. Variations include shelf ready packaging which can be placed directly on a shelf in a supermarket for a consumer to pick from, or carry-out packaging such as a cardboard carry out case for multiple bottles of wine so that the consumer can carry the pack away. Tertiary or transport packaging is that which is used to facilitate handling and transport of a number of secondary packs in order to prevent handling and transport damage. Typically this packaging can be pallets, stretch-wrap plastic film or shrink-wrapped plastic hoods. This type of packaging could also include additional items such as cardboard corner guards, layer pads or pallet caps.

Package development involves considerations for sustainability, environmental responsibility, and applicable environmental and recycling regulations. It may involve a life cycle assessment which considers the material and energy inputs and outputs to the package, the packaged product, the packaging process, the logistics system, waste management, etc. It is necessary to know the relevant regulatory requirements for point of manufacture, sale, and use. In order for packaging to be optimized, primary, secondary and tertiary packaging must be considered as a total packaging system. Reducing one type of packaging is futile if a corresponding increase is required in another. For example, reducing the thickness of a primary plastic tub is meaningless if the secondary cases that the tubs are packed in need to be strengthened to prevent the tubs from being crushed.

Package design and testing is an integral part of the new package development process. In some cases, development of a package may be a separate process, but is linked closely with the product to be packaged. Package design starts with the identification of all the requirements, for example, structural design, marketing, shelf life, quality assurance, logistics, legal, regulatory, graphic design, end-use, environmental, etc. Further, multiple package designs developed. Computer-aided design, and computer-aided manufacturing, conventional rapid prototyping methodology are used for prototyping each of the designs. Further, the various prototypes are physically tested for sustainability. Subsequently, based on the results, amendments are done in the initial designs. Furthermore, the new prototypes are developed utilizing the amended designs and again physically tested. This conventional design, prototyping, and testing cycle are repeated over a number of times to reach an optimal packaging design. Such conventional cycle for packaging development utilizes a high amount resources and time. Thus, resulting to increased cost and wastage of material.

In another conventional package design process, multiple packages, such as multiple primary packages, multiple secondary packages, and multiple tertiary packages are designed utilizing any computer-aided design tool. Further, conventional simulation tools are used pre-test the multiple package designs individually using simulation methods, to understand the failure scenarios. Subsequently, based on the simulation result these primary packages, secondary packages and tertiary packages shortlisted and prototyped. Further, the prototypes are tested for structural stability and durability, physically. Finally, the package design is optimized based on the obtained test results. In such process, utilizes a high amount resources and time, especially the conventional simulation tools require a high power computing system for simulation, which are very costly. Moreover, such computing systems require hours of computing to be performed for each package and may take months to complete the full set of packages.

Generally in any conventional package design process, testing virtual or real is carried on individual packages. But as described, packaging is a complete system individual optimization package optimization, for example only primary or only secondary package optimization, does not result in to complete packaging optimization. Further, during the package design stage there are numerous permutation combinations of package design, and testing each of these combinations is time consuming and requires high cost. Thus, in the initial stage due to numerous variations of package designs this conventional package design and testing process is slow and costly. In view of such costly and slow process, companies typically end up spending substantial amount of money or neglect the process completely. Further, such neglected package design process later results in business losses due to package failures.

In accordance with the present subject matter, a method and system for package testing and optimization is described. In the said implementation, primary input data is obtained. The primary input data includes package design, material models, boundary conditions, test parameters, finite element analysis data, multibody dimension data, experimental data and historical data. The package design includes primary package design, secondary package design, and tertiary package design. Material models include the material properties, strength properties, other characteristics of the package. Boundary conditions include the environmental conditions for example, humidity, temperature, pressure. Tests parameters include the testing criteria, for example, the drop height for performing the drop test, vibration profile for the vibration tests etc., the number of test to be performed or the order to be performed. Historical data includes previous package design tests and their results.

Further, utilizing the boundary conditions and test parameters a plurality of tests conditions and tests environments are generated. In an example, the test environment may be a drop test consisting of a drop from a height of 2 meters on a leading edge of a single ply corrugated cardboard box, containing six bottles of shampoo in room of 100% humidity with room temperature of 30° C. at pressure of 1 bar. The test conditions includes the type of test to be performed such as drop test, vibration tests etc., number of test to be performed and the order of test to be performed for example, total no of test 3, test to be performed (drop, vibration), order to be performed drop-vibration-drop.

In the said implementation, test simulations are performed utilizing the plurality of tests conditions, tests environments and primary input data to obtain simulation data. The simulation data includes stress strain data, failure data and damage coefficient data across various time intervals for all tests. Further, the tests are performed in a predetermined order included in the test conditions on the same cardboard box. During the test simulations process residual strains retained at the end of each test are recorded and are transferred in to the subsequent test. In an implementation, the strain and damage sustained by a package at the end of a test is converted in to a damage coefficient which is further transferred to the next test. Further, utilizing the simulation data and a predefined filtering and evaluation criterion at least one interpolation constant is developed and may be stored in the database. In an implementation, the simulation is repeated for multiple primary input data to obtain interpolation constants, which are further stored in the databased to obtain an interpolation constant database. Further, in an implementation a preprocessing of the primary input data is performed utilizing a design for experiment methodology to identify a set of primary input data from which the simulation is performed. Further, all the simulation data, interpolation constant and its corresponding primary data is stored in the databased.

In the said implementation, secondary input data, interpolation constant data and sublimation data is obtained. The secondary input data includes one or more package design, material data, tests parameters and tests conditions. The package design includes primary package design, secondary package design, and tertiary package design dimensions and parameters and may be same or different from the package design data provided in the primary data. Material models include the material properties, strength properties, other characteristics of the package. Tests parameters include the testing criteria, for example, the drop height for performing the drop test, vibration profile for the vibration tests etc. The test conditions includes the type of test to be performed such as drop test, vibration tests etc., number of test to be performed and the order of test to be performed for example, total no of test 3, test to be performed (drop, vibration), order to be performed drop-vibration-drop.

In the said implementation, one or more package testing equation is generated based on the secondary input data and interpolation constant. The package testing equation is utilized to further compute stress and strain values and coefficient of damage of various package designs included in the secondary input data. In an implementation the package testing equation may be developed for each node of the package design, for each of the test condition, and a predefined time step. In one more implementation the package testing equation may be developed for the complete package for example a plurality of bottle in a secondary package. In the said implementation the stress, strain values and damage coefficient values may be computed for each node, at a predefined time step for each test. Furthermore, a collective stress and strain values and damage coefficient is computed for the complete package design. Subsequently the package designs are evaluated utilizing the computed individual and collective stress strain data, damage coefficient and an evaluation criterion to enable an optimized package development.

In accordance to the present subject matter, the system and method for package testing reduces the number of cycles of packaging design development and testing by evaluating and identifying safe package designs, from a vast pool of design combinations of primary, secondary and tertiary packaging, which may be further optimized. In accordance to the present subject matter, this is enabled because the simulation is performed for only a limited predefined set of package designs, and other and new designs are evaluated utilizing the methodology described in the present subject matter. Thus, the total time required for computation is reduced. Furthermore, prototyping and physical testing may only be performed of the final optimal design for validation, thus reducing wastage of resources. Thus there is an overall reduction in the cost of package design, testing, and optimization. These and other features along with the advantages of the present subject matter will be further evident in the subsequent detailed description in conjunction with the figures.

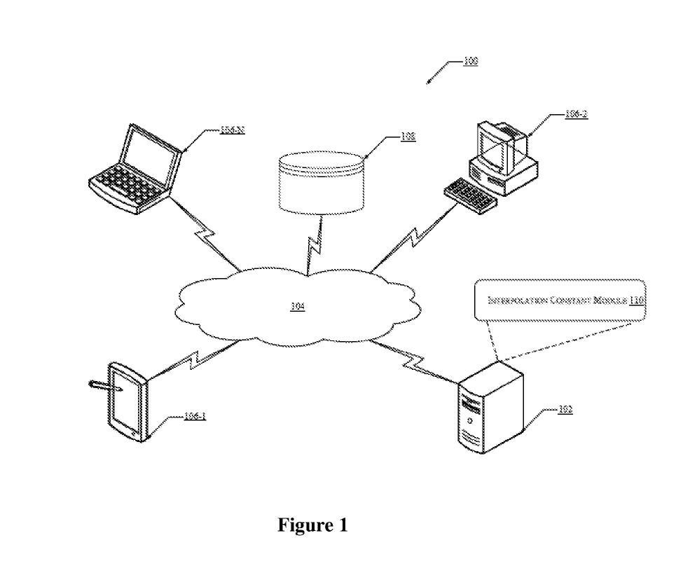

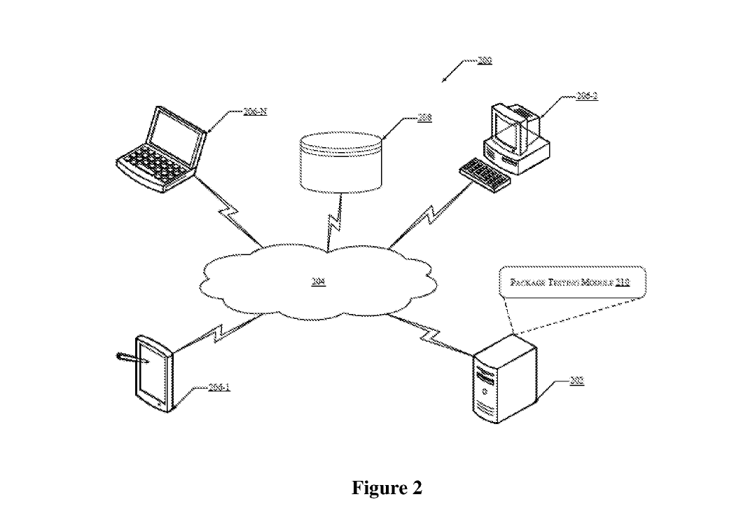

FIG. 1, FIG. 2 illustrates a network environment 100, 200, implementing a package testing primary system 102, and a package testing secondary system 202. In the said implementation, the package testing primary system 102, the package testing secondary system 202, herein after referred as the primary system 102 and secondary system 202 respectively, configured to perform virtual package testing for evaluation of package designs and optimization. In another implementation, the primary system 102 and secondary system 202 may be included in an already implemented information technology system or any package design system. In one more implementation, the package testing primary system 102, the package testing secondary system 202 may be implemented in the same network environment. In one more implementation the package testing primary system 102, the package testing secondary system 202 may be implemented as a single system. In another implementation, the package testing primary system 102, the package testing secondary system 202 may be geographically same or different region. Further, the utilization of the package testing primary system 102, the package testing secondary system 202 may be done one after another continuously, simultaneously or in different time intervals.

The primary system 102 and secondary system 202 may be implemented in a variety of computing system, such as laptop computer, a desktop computer, a notebook and the like. Further, the primary system 102 may be communicatively coupled to user devices 106-1, 106-2 . . . , 106-N, collectively referred to as device(s) 106. Furthermore, the secondary system 202 may be communicatively coupled to user devices 206-1, 206-2 . . . , 206-N, collectively referred to as device(s) 206. In implementation device 106 and 206 may be same. For example, the devices 106 and 206 may include, but not limited to a desktop computer, a mobile phone, a handheld device, a workstation, and a laptop computer. In another implementation, the primary system 102 may be implemented inside the device 106 and the secondary system 202 may be implemented inside the device 206. In one more implementation the primary system 102 and the secondary system 206 may be implemented inside the same device 106 or device 206. Moreover, the devices 106 and 206 individually may be located in geographically distant location from each other as well as the primary system 102 and secondary system 202, respectively.

In another implementation, the devices 106 and 206 and the primary system 102 and secondary system 206 may be communicatively coupled through a network 104 and network 204, respectively. The network 104 and network 204 may be a wireless network, wired network or a combination thereof. The network 104 and network 204 can be implemented as one of the different types of network such as intranet, local area network (LAN), wide area network (WAN), the internet and such. The network may either be a dedicated network or a shared network, which represents an association of the different types of network that use a variety of protocol for example, Hypertext Transfer Protocol (HTTP), Transmission Control Protocol/Internet Protocol (TCP/IP), Wireless Application Protocol (WAP) for communication. Further, the network 104 and network 204 may include a variety of network devices, including but not limiting to routers bridges, servers, computing devices, storage devise. For maintaining readability adhering to the subject matter of the present invention, the variety of network devices have not been described. It may be understood that the network may include all the various network devices, as known to a person skilled in the art.

In the implementation a database 108 and a database 208 is communicatively coupled directly to the primary system 102 and secondary system 202 respectively or through the network 104 and network 204 respectively. The database 108 and database 208 may be located in a geographically similar location or in a geographically distinct location as the primary system 102, and secondary system 202 or any of the devices 106 and 206 respectively. In another implementation the database 108 and 208 may be located internally to the primary system 102 and secondary system 202 or the device 106 and 206 or a combination thereof. The database 108 and 208 may store or provided access historical data and physical data. In one more implementation database 108 and database 208 may be combined to form a single database.

In accordance with the present subject matter, the primary system 102 and secondary system 202 are configured to perform virtual testing of packaging designs and evaluating the packaging design for optimization. In the said implementation, the primary system 102 obtains primary input data. In an example, the primary input may be provided from by the user via the device 106. In another example the system may obtain the primary input data from the database 108. The primary input data includes package design, material models, boundary conditions, test parameters, historical data. The package design includes primary package design, secondary package design, and tertiary package design. Material models include the material properties, strength properties, other characteristics of the package. Boundary conditions include the environmental conditions for example, humidity, temperature, pressure. Tests parameters include the testing criteria, for example, the drop height for performing the drop test, vibration profile for the vibration tests etc., and the number and order of tests to be performed. Historical data includes previous package design tests and their results.

Further, the primary system 102 is configured to generate test environment and test conditions based on the boundary conditions and test parameters. In another implementation, the system may be configured to generate tests environment and test conditions and store in database 108. Further, during package testing the primary system 102 may be configured to obtain the previously generated tests data for package testing.

Subsequently, the primary system 102 is configured to perform test simulations utilizing the plurality of test environments, test conditions and primary input data. The tests simulation may be performed in a random order or in a predefined order. In an example artificial neural network may be utilized. In another example, closed function method maybe utilized. Further, the primary system 102 is configured store the simulation data. In one implementation the residual stress and damage coefficient at the end of each test, at predefined time interval or a combination thereof may be recorded. In one more implementation residual strain, geometric changes or a combination thereof may be recorded and stored as simulation data. In one other implementation one or more of a percentage of safety, a damage coefficient, a probability of failure and interpolation constant are recorded as the simulation data.

In addition, the primary system 102 may be configured to develop at least one interpolation constant utilizing the simulation data and predefined filtration criteria. In an implementation the package designs may be classified in a multiple categories based on the recorded data and the predefined filtration criteria and interpolation constants are developed. Further, in an implementation one or more iteration of the above step is performed of one or more primary input data and the simulation data is recorded for each of the iteration. In an implementation the simulation data and interpolation constants may be recorded in database 108.

In the said implementation, the secondary system 202 obtains secondary input data, simulation data and interpolation constant data. In an example, the secondary input may be provided from by the user via the device 206. In another example the system may obtain the secondary input data, simulation data and interpolation constant data from the database 208 and 108. The secondary input data includes package design, material models, test condition, test parameters, historical data. The package design includes primary package design, secondary package design, and tertiary package design dimensions and parameters. Further, the package designs may be provided as a range of dimensions, same or different from the package design data provided in the primary input data. Material models include the material properties, strength properties, other characteristics of the package. Tests parameters include the testing criteria, for example, the drop height for performing the drop test, vibration profile for the vibration tests etc. Historical data includes previous package design tests and their results. The test conditions includes the type of test to be performed such as drop test, vibration tests etc., number of test to be performed and the order of test to be performed for example, total no of test 3, test to be performed (drop, vibration, compression), order to be performed drop-vibration-compression.

In the said implementation, the secondary system 202 generates one or more package testing equations based on the secondary input data and interpolation constant. In an implementation the package testing equation may be developed for each node of the package design, for each of the test condition, and a predefined time step. In one more implementation the package testing equation may be developed for the complete package.

Further, the secondary system 202 utilizes package testing equation is to compute stress and strain values and damage coefficient of various package designs included in the secondary input data. In the said implementation the stress, strain values and damage coefficient values may be computed for each node, at a predefined time step and for each test. Furthermore, a collective stress and strain values and damage coefficient is computed for the complete package design.

Subsequently, the secondary system 202 evaluates the package designs are utilizing the computed individual and collective stress strain data, damage coefficient and an Failure identification matrix to enable an optimized package development. In an implementation the system 202, further utilizes a 3 dimensional visualization approach to indicate the damage sustained by the package during testing and demonstration of pass/fail scenario. Furthermore, in case of failure, if observed, the system 202 may recommends design changes that would overcome the identified failures. In one more condition, if the user requests the system 202, it may also suggest design changes for package design optimization.

In one implementation, the system 202 based on the evaluated package designs identifies the suppliers or organizations or companies or a combination thereof supplying the same or a substantially the same package or packaging material as compared to the evaluated package designs. Furthermore, the system may also identify the various other departments or sister organizations obtaining the similar packaging material as compared to the evaluated package designs locally as well as globally. This further enables effective decision making

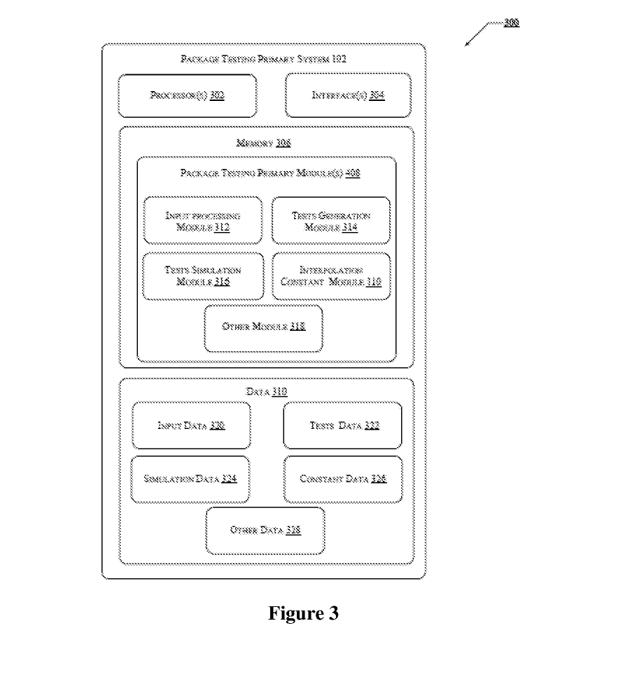

FIG. 3 illustrates the exemplary components of the primary system 102, according to an embodiment of the present subject matter. In one embodiment, the primary system 102 includes a processor(s) 302, interface(s) 304, a memory 306 coupled to the processor(s) 302, and a data 310 coupled to the processor(s) 302.

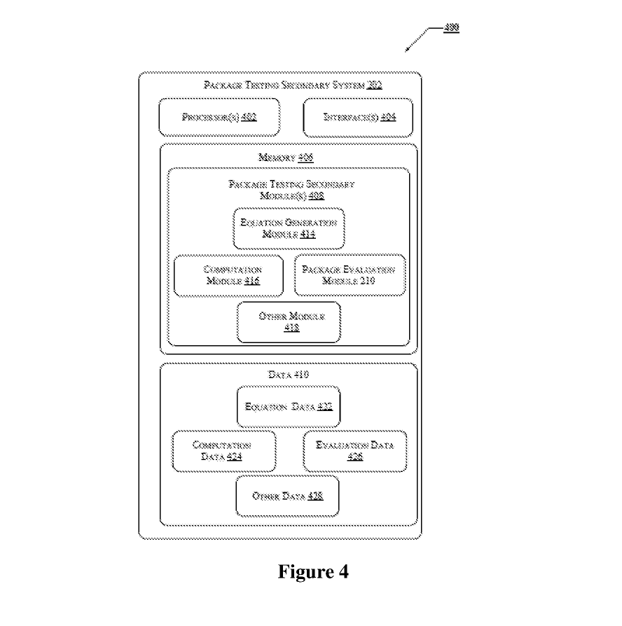

FIG. 4 illustrates the exemplary components of the secondary system 202, according to an embodiment of the present subject matter. In one embodiment, the secondary system 202 includes a processor(s) 402, interface(s) 404, a memory 406 coupled to the processor(s) 402, and a data 410 coupled to the processor(s) 402.

The processor(s) 302 and 402 may be implemented as one or more microprocessors, microcomputers, microcontrollers, digital signal processors, central processing units, state machines, logic circuitries, and/or any devices that manipulate signals based on operational instructions. Among other capabilities, the processor(s) 302 and 402 is configured to fetch and execute computer-readable instructions stored in the memory 306 and 406.

The interface(s) 304 and 404 may include a variety of software and hardware interfaces, for example, a web interface, a graphical user interface, etc., allowing the primary system 102 and secondary system 202 to interact with the devices 104 and 204. Further, the interface(s) 304 and 404 may enable the primary system 102 and secondary system 202, respectively, to communicate with other computing devices, such as web servers and external data servers (not shown in figure). The interface(s) 304 and 404 can facilitate multiple communications within a wide variety of networks and protocol types, including wired networks, for example LAN, cable, etc., and wireless networks such as WLAN, cellular, or satellite. The interface(s) 304 and 404 may include one or more ports for connecting a number of devices to each other or to another server.

The memory 306 and 406 can include any computer-readable medium known in the art including, for example, volatile memory, for example, Random Access Memory (RAM), and/or non-volatile memory, for example, Erasable Programmable Read Only Memory (EPROM), flash memory. In one embodiment, the memory 306 includes package testing primary module 308 (primary module(s) 308) and the memory 406 includes package testing secondary module 408 (secondary module(s) 408).

In one implementation, the primary module 308 further include an input processing module 312, a test generation module 314, a test simulation module 316 and interpolation constant module 110. The primary module 308 may also include other modules 318 for providing various other functionalities of the system 102. It will be appreciated by any person skilled in the art, that such modules may be represented as a single module or a combination of different modules.

In one implementation, the secondary module 408 further includes a, an equation generation module 414, a computation module 416, and evaluation module 210. The modules 208 may also include other modules 418 for providing various other functionalities of the package testing system 202. It will be appreciated by any person skilled in the art, that such modules may be represented as a single module or a combination of different modules.

The data 310 and 410 serves, amongst other things, as a repository for storing data fetched, processed, received and generated by one or more of the primary modules 308 and secondary modules 408. In one implementation, the data 310 may include input data 320, test data 322, simulation data 324, constant data 326 and other data 238. In one implementation, the data 410 may include equation data 422, computation data 424, evaluation data 426, and other data 4288. In one embodiment, the data 310 and 410 may be included in the memory 306 and 406 respectively in the form of data structures. Additionally, the aforementioned data can be organized using data models, such as relational or hierarchical data models.

In an example, a shampoo manufacturing company intends to revamp its shampoo bottles with new designs. Keeping this objective in mind, the shampoo manufacturing company develops multiple package designs and has a pool of package designs it is using or was using for its products. Then a selection of a finite number of package designs is made from the pool of package designs which includes new and old package designs. In the said example, design of experiment methodology is used. Further, the shampoo manufacturing company may utilize the system 102 and 202 to perform a plurality of tests on the package designs and evaluate the package designs to optimize the package designs.

In an implementation, the input processing module 312 is configured to obtain primary input data. The input data includes package design, material models, boundary conditions, test parameters, tests details, experimental data, finite element analysis data, multibody dimensional data and historical data. The package design includes primary package design, secondary package design, and tertiary package design. In an implementation the package design may be a finite number selected from a pool of new or old package designs. Further, the selection may be performed using a design of experiment methodology. Material models include material properties, strength properties, and other characteristics of the package. Boundary conditions include environmental conditions for example, humidity, temperature, and pressure. Tests parameters include the testing criteria, for example, the drop height for performing the drop test, vibration profile for the vibration tests etc. Test details included the total number of tests, order of tests, and type of tests. Historical data includes previous package design tests and their results. In addition, the input processing module 312 is configured to store the input data in the input data 320.

In the described example of the shampoo manufacturing company, the input processing module 312 is configured to obtain primary input data. The input data includes package designs, test parameters, material models, tests details, Finite Element analysis data, multibody dimension data and historical data. The package design includes cad models of the primary package, secondary package and tertiary package. Material model includes the material model of the shampoo container, and the corrugated cardboard sheet used for secondary and tertiary packaging. Tests details include number tests=5, type of tests-drop tests, vibration tests, order of test-first drop tests and then vibration tests. Tests parameters include drop height of 5 meters, and vibration profile. The input processing module 312 is further configured to store the input data in the input data 320.

Further to the said implementation, tests generation module 314 is configured to generate test environments and tests conditions based on the input data. The tests conditions may be described as the physical tests to be performed. The tests environments mimic the real world environmental condition any package may be subjected too during it life cycle. In an implementation, the generation of test environment and tests conditions by tests generation module 314 may be real time. In another implementation, the tests environments and tests conditions may be generated by tests generation module 314 beforehand and stored in the database 108 and may be obtained by the tests generation module 314 when required. The test generation module is further, configured to store the tests environment and tests conditions in the tests data 314.

In the said example of shampoo manufacturing company, tests generation module 314 is configured to generate test environments and tests conditions based on the input data. The tests environment and tests conditions include a drop tests environment and a vibration tests environment. The drop tests environment generated is a drop from a height of 5 meters on the leading edge of the package designs in an environment of 60% humidity. The vibration tests environment generated is a vibration of the packaging in a vibration profile of high intensity in humidity of 80% and pressure 1 bar.

Furthermore, the tests simulation module 316 is configured to obtain the generated tests environments and tests conditions and perform tests simulations. The tests simulations may be described as performing the tests utilizing in test environment in a predefined order. During the tests simulations tests simulation module 316 is configured to compute a damage coefficient or a strain or a combination thereof at the end of each tests and transfer it to the next tests. In an implementation the damage coefficient may be computed for each a predefined time interval for each test. The damage coefficient is indicative of the damage sustained by the package design. The damage coefficient improves the relation between the tests performed by effectively creating a link between the previous tests and the next test. This effectively recreates the real world conditions of a package under multiple loads and effects while continuously sustaining damage. The test simulation module 316 is configured to store the test simulation data, package failure data stress strain values and the damage coefficient to simulation data 324. In an implementation artificial neural network may be utilized for tests simulations. Further, in an implementation one or more iteration of the above step is performed for one or more primary input data and the simulation data is recorded for each of the iteration.

In the said example of shampoo manufacturing company, the tests simulation module 316 obtains the drop tests environment and vibration tests environment, and performs the tests simulations. The tests simulation module 316 performs the drop test on the package designs and computes a coefficient of damage oat the end of the tests. Further, tests simulation module 316 performs the vibration tests utilizing the coefficient of damage computed at the end of the drop tests and the vibration tests environment. Furthermore, coefficient of damage at the end of the vibration tests is computed. In addition the tests simulation module 316 stores the simulation data in simulation data 324.

In the described implementation, the interpolation constant module 110 is configured to develop at least one interpolation constant utilizing the simulation data and predefined filtering criteria. In an implementation, one or more interpolation constants are developed for one or more simulated data of distinct primary input data. In an example, the interpolation constant may be developed utilizing a multivariable regression analysis methodology. A multivariable regression analysis methodology is a statistical technique that uses several explanatory variables to predict the outcome of a response variable. Further, the interpolation constant module 110 is configured to store the interpolation constant data and the simulation data in constant data 326.

In the said example of shampoo manufacturing company, the interpolation constant module 110 is develops interpolation constants (3.45, 3.4, 5.7, 7.8) for drop and (32.8, 4.7, 4.9, 6.8) for vibration utilizing the simulation data and predefined filtering criteria. The interpolation constant module 110 stores the interpolation constant data and the simulation data in constant data 326.

In the implementation, the equation generator module 414 obtains secondary input data, simulation data and interpolation data. In an example, the secondary input may be provided from by the user. In another example the system may obtain the secondary input data from a database. The secondary input data includes package design, material models, test condition, test parameters, historical data. The package design includes primary package design, secondary package design, and tertiary package design dimensions and parameters. In an example a range of package design dimensions may be provided. Material models include the material properties, strength properties, other characteristics of the package. In an example a range with a minimum and a maximum may be provided. Tests parameters include the testing criteria, for example, the drop height for performing the drop test, vibration profile for the vibration tests etc. Historical data includes previous package design tests and their results. The test conditions includes the type of test to be performed such as drop test, vibration tests etc., number of test to be performed and the order of test to be performed for example, total no of test 3, test to be performed (drop, vibration, compression), order to be performed drop-vibration-compression.

In the said example of shampoo manufacturing company, the company has new package design that it wants to be virtually tested. Further, the equation generator module 414 obtains secondary input data, simulation data and interpolation data. In the said example, the dimensions of the new package are length=54 mm, breath=34 mm, height=78 mm.

In the described implementation, the equation generator module 414 configured to generates one or more package testing equation based on the secondary input data and interpolation constant. In an implementation the package testing equation may be developed for each node of the package design, for each of the test condition, and a predefined time step. In one more implementation the package testing equation may be developed for the complete package. Further, the equation may be developed for stress, strain and damage coefficient. Further, the equation generator module 414 stores the equations in the equation data 422.

In the said example of shampoo manufacturing company the equation generator module 414 generates package testing equations based on the secondary input data and interpolation constant. In the said example, the equation generated are

3.45*x²+3.4*y²−5.7*x*y*z+7.8*z²=Damage coefficient for drop (1)

32.8*x²−4.7*y²+4.9*x*y*z−6.8*z²=Damage coefficient for vibration (2)

Wherein:

x=is the length of the package;

y=is the breadth of the package;

z=is the height of the package;

In the implementation, the computation module 416 utilizes package testing equation stored in the equation data 422 to compute stress and strain values and damage coefficient of various package designs included in the secondary input data. In the said implementation the stress, strain values and damage coefficient values may be computed for each node, at a predefined time step and for each test. Furthermore, a collective stress and strain values and damage coefficient is computed for the complete package design.

In the said example of shampoo manufacturing company the computation module 416 utilizes the package testing equation data 422 and secondary input data to compute damage coefficient. In the said example the Damage coefficient for drop==−571.95 and Damage coefficient for vibration=1506.28. Further, the Collective damage coefficient=Damage coefficient for drop+Damage coefficient for vibration=934.33.

According in the said implementation, the package evaluation module 210 is configured evaluate the one or more package designs utilizing the individual and collective stress strain values and damage coefficient and failure identification matrix. Further, a safe design may be identified based on failure identification matrix. In an example, the evaluation may be in the form of a pass fail output. In another example it may be in the form of percentage safety or probability of failure. In one implementation, package evaluation module 210 further utilizes a 3 dimensional visualization approach to indicate the damage sustained by the package during testing and demonstration of pass/fail output. Furthermore, the package evaluation module 210 is configuring to store the evaluation results in the evaluation data 426. In an implementation, based on the simulation data the package evaluation module 210 may be configured to recommend the changes to be performed to optimize the package design. In an implementation the recommendation may be suggesting percentage change or design change or dimension change to be performed on the package designs for obtaining an optimized package design.

In one implementation, the package evaluation module 210 based on the evaluated results identifies the suppliers, organizations, companies or a combination thereof supplying the same or a substantially the same evaluated package design or the suggested package design or packaging material. Furthermore, the package evaluation module 210 may also identify the various other departments or sister organizations obtaining the similar packaging material as compared to the evaluated package designs or the suggested package design locally as well as globally. This further enables effective decision making.

In the said example of shampoo manufacturing company, the package evaluation module 210 obtains the individual and collective stress strain values and damage coefficient and failure identification matrix at the end of drop tests and the vibration test. Utilizing the simulation data and the damage coefficient and a predefined failure identification matrix the package evaluation module 210 evaluates the package in to safe designs and unsafe designs. Further, the package evaluation module 210 suggests percentage change or design change to be performed on the package designs for optimization. Furthermore, package evaluation module 210 also identifies suppliers same or substantially same package material and its various departments and sister organizations procuring the same or substantially same package material. Thus, in accordance with the present subject matter package testing and evaluation of multiple package designs is enabled. In the said example of shampoo manufacturing company package evaluation module 210 obtains the damage coefficients=−571.95, 1506.28, 934.33 and utilizes a failure identification matrix which includes a safety values for various conditions and evaluates the design to be a pass. Furthermore, the evaluation module suggests a new set of dimensions utilizing the evaluated package design dimensions, which could optimize the package design resulting in a material saving of 20%.

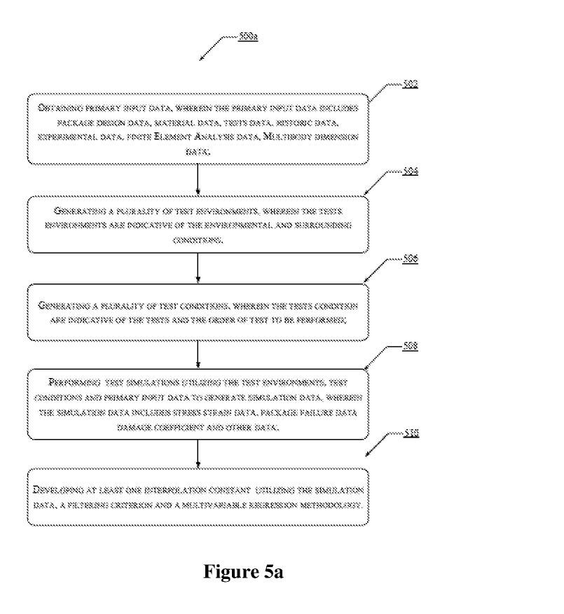

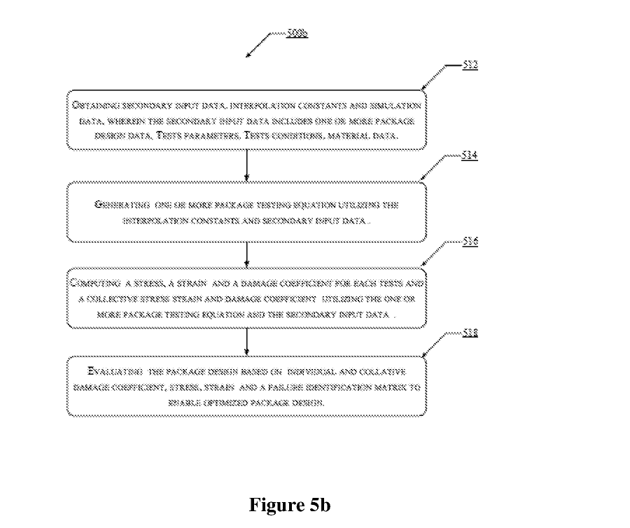

FIG. 5a and FIG. 5b illustrates an exemplary method 500a and 500b for performing virtual testing of packaging designs and evaluating for optimum package design, according to an embodiment of the present subject matter. The method 500a and 500b may be described in the general context of computer executable instructions. Generally, computer executable instructions can include routines, programs, objects, components, data structures, procedures, functions, and modules, which perform particular functions or implement particular abstract data types. The method 500a and 500b may also be practiced in a distributed computing environment where functions are performed by remote processing devices that are linked through a communication network. In a distributed computing environment, computer executable instructions may be located in both local and remote computer storage media, including memory storage devices. In an implementation method 500a and 500b may be performed one after another or in different time intervals.

The order in which the method 500a and 500b is described is not intended to be construed as a limitation, and any number of the described method blocks can be combined in any order to implement the method 500a and 500b, or alternative methods. Additionally, individual blocks may be deleted from the method 500a and 500b without departing from the spirit and scope of the subject matter described herein. Furthermore, the method 500a and 500b can be implemented in any suitable hardware, software, firmware, or combination thereof.

With reference to method 500a as depicted in FIG. 5a, as shown in block 502, primary input data is obtained. The primary input data includes Package Design Data, Material data, Tests Data, Experimental data, finite element analysis data, multibody dimension data, Historic data.

As depicted in block 504, a plurality of tests environments are generated. The tests environment indicative of the real world environment and the conditions a package may undergo during its life cycle. In other example, the tests environment mimics the surrounding any package is subjected too during the course of its life. For example, a humidity environment of 80 at 1.5 bars pressure.

As shown in block 506, a plurality of test conditions is generated. The test conditions are indicative of the physical test to be performed. Further, they also include the order of the tests to be performed. For example the tests condition may include a drop tests, a vibration tests, and a crush test and the order of the tests, drop-vibration-crush.

As illustrated in block 508, test simulations are performed based on the plurality of test environments, test condition and primary input data and simulation data is recorded. For example, the simulation of the package design may be dropped from a height of 5 meters to perform drop tests and subjected a force of 5 N to perform crush tests.

As illustrated in block 510, at least one interpolation constant is developed utilizing the simulation data, and filtration and evaluation criterion. In an example the one or more interpolation constants, be developed using multivariable regression analysis.

With reference to method 500b as depicted in FIG. 5b, as shown in block 512, secondary input data, interpolation constant data and simulation data is obtained. The secondary input data includes one or more Package Design Data, Material data, Tests parameters and tests conditions.

As illustrated in block 514, one or more packaging testing equation are developed utilizing one or more interpolation constant, secondary input data. In an implementation, the package testing equations may be developed for each node, for each tests, for a predefined time interval or a combination there of.

As illustrated in block 516, stress strain value and damage coefficient for each tests and a collective stress strain value and damage coefficient is computed utilizing the package testing equation.

As illustrated in block 518, the one or more package design is evaluated based on the individual and collective stress strain value and damage coefficient and a failure identification matrix for optimized package development.

In the present document, the words “exemplary, embodiment, implementation” are used to mean “serving as an example, instance or illustration”. Any embodiment or implementation or example is not to be constructed as preferred or advantages over other embodiment.

We claim:

1. A method for package testing and optimization, the method comprising:
generating at least one package testing equation utilizing one or more interpolation constant and a secondary input data;
computing one or more of a stress, a strain, a damage coefficient, collective stress collective strain and collective damage coefficient utilizing the package testing equation and the secondary input data, wherein the damage coefficient is indicative of the damage sustained by the package ; and
evaluating the package design based one or more of a stress, a strain, a damage coefficient, collective stress, collective strain and collective damage coefficient and a failure identification matrix to enable optimized package design.

2. The method as claimed in claim 1, wherein the method further comprises obtaining secondary input data, one or more interpolation constant data and simulation data, wherein the secondary input data includes one or more package design data, tests parameters, tests conditions, material data.

3. The method as claimed in claim 1, wherein the method further comprises
suggesting percentage change or design change or dimension change to be performed on the package designs obtaining an optimized package design; and
identifying one or more of suppliers supplying the material of the evaluated package design or the optimized package design.

4. The method as claimed in claim 1, the package testing equation are generated for at least one of a one or more tests conditions, a one or more time intervals, a one or more package designs.

5. A method for package testing and optimization as claimed in claim 1, the method comprising:
obtaining a primary input data, wherein the primary input data includes package design data, material data, tests Data, experimental data, finite element analysis data, multibody dimension data, historic data;
generating a plurality of tests environments and a plurality of tests condition utilizing the primary input data wherein the tests environments are indicative of real world environment and the tests conditions are indicative of the tests to be performed;
performing one or more tests simulation on a plurality of package designs utilizing the plurality of tests environments, the plurality of tests conditions and the primary input data; and
developing the one or more interpolation constant utilizing the simulation data, a filtering criterion.

6. The method as claimed in claim 5, wherein the one or more tests simulation are preformed utilizing on artificial neural network.

7. The method as claimed in claim 5, wherein the one or more interpolation constants are developed utilizing a multivariable regression methodology.

8. The method as claimed in claim 5, wherein the performing further includes computing a damage coefficient at the end of each of the one or more tests simulation; and
transferring the damage coefficient to the subsequent one or more tests simulation.

9. A package testing secondary system (202), the system (202) comprising:
a processor (402); and
a memory (406) coupled to the processor (402), the memory (406) comprising:
an equation generator module (414) wherein the equation generator module (414) is configured to
obtain secondary input data, one or more interpolation constant and simulation data, wherein the secondary input data includes one or more package design data, Tests parameters, Tests conditions, material data; and
generate at least one package testing equation utilizing the one or more interpolation constant and the secondary input data;
a computation module (416), wherein the computation module (416) is configured to compute one or more of a stress, a strain, a damage coefficient, collective stress collective strain and collective damage coefficient utilizing the one or more package testing equation and the secondary input data, wherein the damage coefficient is indicative of the damage sustained by the package; and
an package evaluation module (210), wherein the evaluation module (210) is configured to evaluate the package design based on one or more of the stress, the strain, the damage coefficient, the collective stress, the collective strain and the collective damage coefficient and a failure identification matrix to enable optimized package design.

10. The package testing secondary system (202), as claimed in claim 9, further comprising:
an input processing module (312), wherein the input processing module (312) is configured to obtain a primary input data, wherein the primary input data includes package design data, material data, tests data, experimental data, finite element analysis data, multibody dimension data, historic data; and
a tests generation module (314), wherein the tests generation module (314) is configured to generate a plurality of tests environments and a plurality of tests condition utilizing the primary input data wherein the tests environments are indicative of real world environment and tests conditions are indicative of the tests to be performed
a tests simulation module (316), wherein the tests simulation module (316) is configured to perform one or more tests simulation on a plurality of package designs utilizing the plurality of tests environments, the plurality of tests conditions and primary input data; and
an interpolation constant module (110), wherein the interpolation constant module (110) is configured to develop one or more interpolation constant utilizing the simulation data, a filtering criterion.

11. The package testing secondary system (202) as claimed in claim 10 wherein the evaluation module (216) is further configured to
compute a coefficient of damage at the end of each of the one or more tests simulation; and
transfer the coefficient of damage to the subsequent one or more tests simulation.

12. The package testing secondary system (202) as claimed in claim 9 wherein the evaluation module (216) is further configured to
suggest percentage change or design change or dimension change to be performed on the package designs obtaining an optimized package design; and
identify one or more of suppliers supplying the material of the evaluated package design or the optimized package design.

13. A non-transitory machine-readable medium having embodied thereon a machine readable instruction for executing a method for package testing and identification, the method comprising:
generating one or more package testing equation utilizing a interpolation constant and a secondary input data, wherein at least one interpolation constant are developed utilizing, a primary input data, a simulation data, a filtering criterion;
computing one or more of a stress, a strain, a damage coefficient, collective stress collective strain and collective damage coefficient utilizing the one or more package testing equation and the secondary input data, wherein the damage coefficient is indicative of the damage sustained by the package; and
evaluating the package design based one or more of the stress, the strain, the damage coefficient, the collective stress collective strain and the collective damage coefficient and a failure identification matrix to enable optimized package design.
